(19) United States
(12) Patent Application Publication
(10) Pub. No.: US 2003/0205606 A1
(43) Pub. Date: Nov. 6, 2003

(54) Nailing machine

(76) Inventor: Giancarlo Storti, Cremona (IT)

Correspondence Address: Kirschstein, Ottinger, Israel & Schiffmiller, P.C., 489 Fifth Avenue, New York, NY, 10017-6105, US

(21) Appl. No.: 10/429,008

(22) Filed: May 2, 2003

(30) Foreign Application Priority Data
May 3, 2002 (IT) MI2002A-000942

(51) Int. Cl. B25C 5/00

(52) U.S. Cl. 227/100; 227/99

(57) ABSTRACT

A nailing machine for pallets, comprises nailing grippers supported by a beam which is controllably movable in a vertical plane and includes feeding bins for feeding nails to the grippers, with a plurality of gripper holding beams movable in a vertical plane, a central gripper holding beam being supported by a locally fixed construction, adjoining gripper holding beams being adapted to be properly positioned with respect to the workpiece to be nailed.

### BACKGROUND OF THE INVENTION

The present invention relates to a nailing machine.

As it is known, for making different articles of manufacture, constituted by wood elements, nailing machines, provided for firmly coupling wood pieces such as battens, blocks or strips, to provide a finished product are conventionally used.

One of the above mentioned articles, usually made on an industrial scale, comprises the so-called shipment and storing pallets, including a plurality of parallel wood battens, so arranged as to form a bearing surface for goods being transported.

The parallel battens bear on cross strips which, in turn, bear on small wood blocks.

Usually, in standardized pallets, said wood blocks are arranged along three geometrical axes, with a mutually parallel relationship.

For making a pallet of the above disclosed configuration, modern nailing lines, as known from the prior art, provide to use a nailing machine which, at a first operating step, nails the constructional elements arranged at a first block or cross member row and which, in a following operating step, clamps the elements arranged at a second block row and then, after a further feeding of the pallet, nails the wood strips of a third block row.

Since, in a prior nailing machine, a nailing operation requires an average operating time of about seconds, it would be apparent that for carrying out, by a prior nailing machine, the above mentioned three nailing steps to provide a standard pallet, about 15 seconds would be required, and, accordingly, the production yield of such a prior nailing machine would approximately correspond to 240 pallets/hour.

Considering that pallet manufacturers require nailing machines with ever-increasing power and speed capabilities, and further considering that for technical reasons the reciprocating times of the nailing gripper supporting ram cannot be further shortened, manufacturers have for quite some time tried to overcome these productive/technological limits however without achieving the desired goals.

### SUMMARY OF THE INVENTION

Accordingly, the aim of the present invention is to overcome the above mentioned drawbacks of the prior art, by providing a nailing machine adapted to drastically reduce the nailing time for making a pallet or a like article of manufacture, which machine, by a single operating stroke, provides a plurality of parallel nailing rows.

According to one aspect of the invention, the above aim is achieved by a nailing machine comprising nailing grippers supported by a supporting beam which is controllably movable in a vertical plane and includes nail feeding bins for feeding nails to said grippers, characterized in that said machine further comprises a plurality of gripper holding beams movable in a vertical plane, that the central gripper holding beam is supported by a locally fixed supporting construction and that adjoining gripper holding beams are supported by supports which can be operatively positioned with respect to a workpiece to be nailed.

By a nailing machine having the above features, it is possible to precisely arrange the workpiece to be nailed under the nailing grippers mounted on a first beam supported by a supporting construction which is locally fixed with respect to the framework of the nailing machine, whereas the front gripper holding beam construction can be precisely arranged at the block or cross-member row arranged at a front end portion of the pallet, the remaining nailing beam construction being adapted to be arranged at the series of blocks provided at the rear end portion of the pallet.

Owing to the provision of a plurality of simultaneously driven hydraulic cylinders, the nailing gripper supporting beams can be simultaneously driven, thereby allowing to make, for example, a standardized pallet with a single operating stroke of all the gripper holding beams, so as to reduce the nailing time per pallet to about 5 seconds.

### BRIEF DESCRIPTION OF THE DRAWINGS

The subject matter according to the present invention will be hereinafter disclosed in a more detailed manner, with respect to an embodiment thereof, given only by way of an example and shown in the accompanying drawings, where:

FIG. 1 is a front view illustrating the nailing machine according to the invention;

FIG. 2 is a further front view illustrating a detail of a nailing machine, the nailing grippers and a pallet being shown in a schematic manner,

FIG. 3 is a side elevation view of the nailing machine; and

FIG. 4 is a schematic top plan view illustrating the main parts of the nailing machine.

### DESCRIPTION OF THE PREFERRED EMBODIMENT

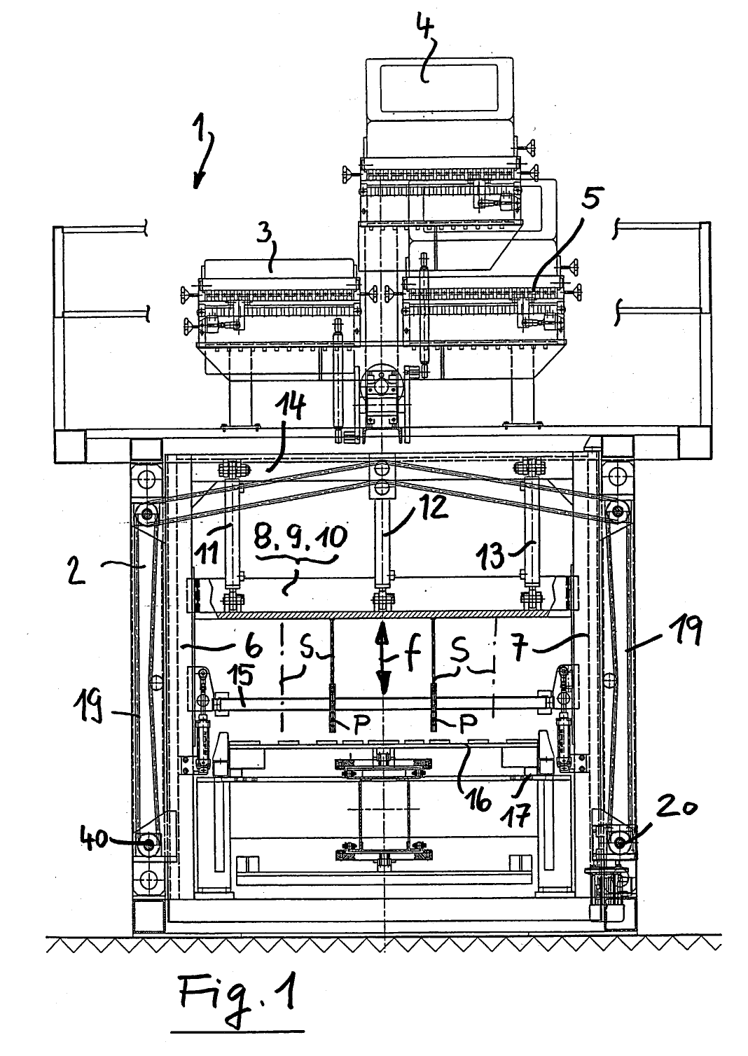

As shown in FIG. 1, the inventive nailing machine, generally indicated by the reference number 1, comprises a strong framework 2, supporting known swinging bins 3, 4 and 5 holding therein the nails to be used.

On a side thereof, the framework 2 comprises parallel guides 6, 7 supporting cross beams 8, 9 and 10. Each beam 8, 9 and 10 is articulately coupled with the piston rods of a plurality of hydraulic cylinders, indicated by 11, 12 and 13.

The top end portions of the hydraulic cylinders 11, 12, 13 of each beam 8, 9, and 10 are in turn articulately coupled to a corresponding top cross member 14 of the framework 2 of the nailing machine 1.

Each beam 8, 9 and 10 can be upward and downward driven by said cylinders 11, 12 and 13 as is shown in FIG. 1 by the arrow f.

In a per se known manner, each beam 8, 9 and 10 operatively supports stem elements S cooperating with tubular grippers P, in turn supported by a cross member 15 above the pallet 16 bearing on a conveyor belt of a nailing plane, schematically indicated by 17.

As the beams 8, 9, 10 are downward driven, the stem elements 6 will enter the grippers P which can be freely horizontally arranged with respect to the body of the underlying pallet 16, to drive nails into the pallet 16 constructional elements.

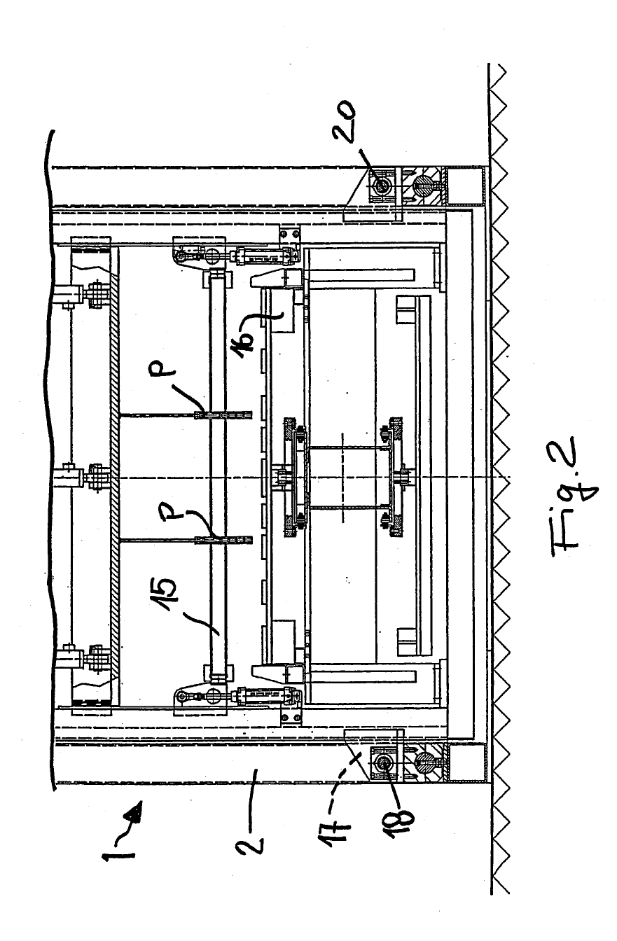

FIG. 2 schematically shows the cross member 13 and related grippers P. In particular, said grippers P are so arranged along the cross member 15, as to allow the pallet 16 elements to be nailed at any desired nailing points.

On the bottom of the framework 2 of the nailing machine, generally indicated by 1, a controlled motor 17 which drives a driving shaft 18 entraining, through belts or chains 19, a further shaft 20 arranged on the opposite side of the framework 2 is provided.

The functions of the above constructional elements will be disclosed in a more detailed manner hereinafter.

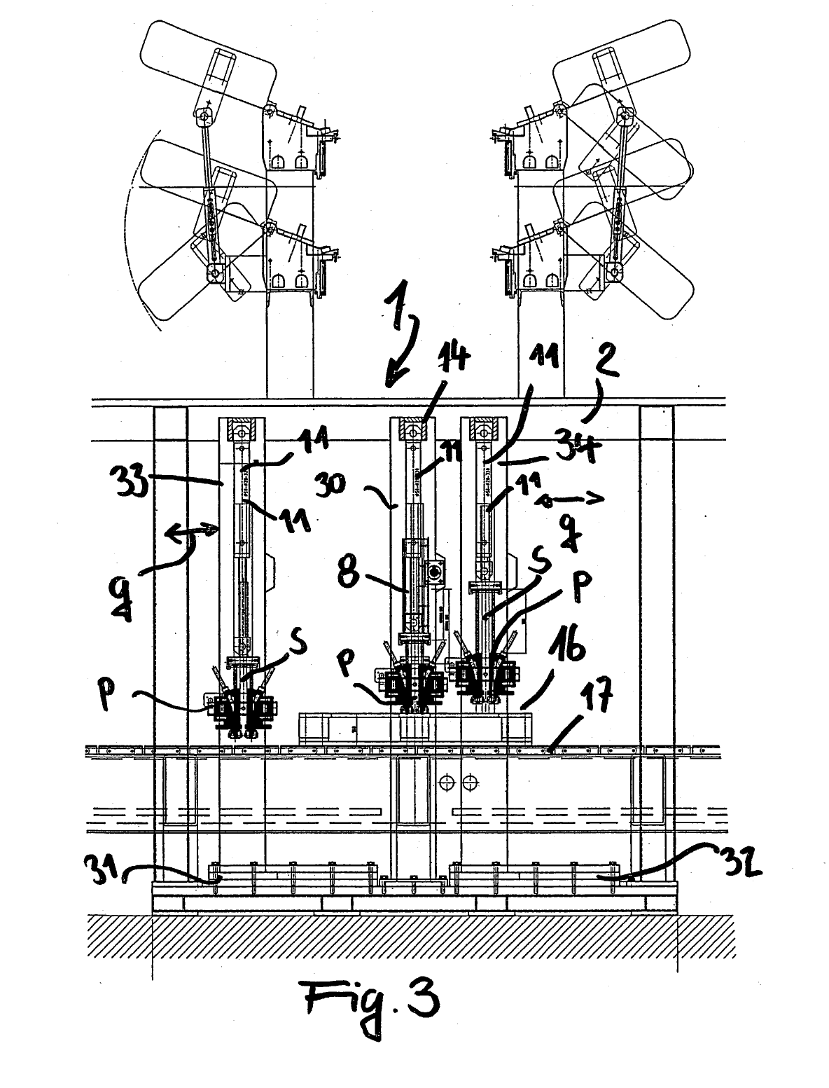

FIG. 3 is a side view of the nailing machine and related framework 2. As shown, said framework 2 supports a plurality of nail bins 3, 4 and 5, storing therein nail elements, which are per se known.

At the center of the framework 2, on both side of the nailing machine, an upright 30 is provided, said upright being locally fixed with respect to the framework 2 of the nailing machine 1.

A cross member 14 (coupled to said uprights) supports said hydraulic cylinders 11, 12 and 13 the piston rods of which affect the underlying beam 8, 9, 10, including the mentioned stem elements which, in turn, affect said grippers P for driving the nail elements into the underlying block of the pallet 16.

At the bottom portion of the framework 2, near the floor, said framework 2 supports mechanical guides 31 and 32, which in turn slidingly support, as indicated by the arrows g, further uprights 33 and 34.

Thus, owing to the provision of the movable uprights 33 and 34, the grippers P supported thereby can be properly arranged with respect to the body of the pallet 16.

As stated, each gripper P engages therewith a known movable stem element S. Moreover, the stem elements S of the uprights 33 and 34 can also be driven by the plurality of pistons generally indicated by 11.

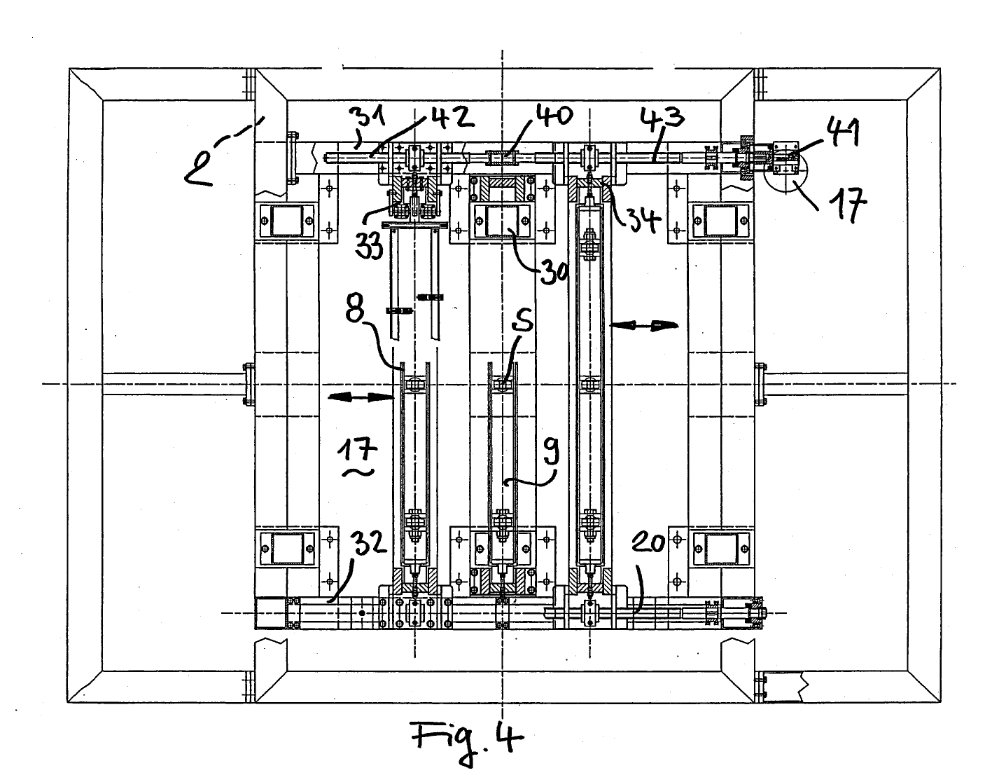

FIG. 4 shows the locally fixed position of the upright 30, on which the central beam 9 is upward and downward movably supported, said central beam 9 affecting, by the stem elements S thereof, said nailing gripper P.

The upright 30 cooperates with a further upright 33 supporting a beam 8 and on the opposite side of said upright 30, which is locally fixed, a further upright 34, also including a movable beam is also provided.

Thus, each beam 33, respectively 34, can be driven in horizontal precision guides 31, 32.

To allow the movable uprights 33 and 34 to be automatically arranged with respect to the fixed central upright 30, near the upright 30 a threaded driving shaft, generally indicated by 40 is provided.

Said shaft is coupled to geared unit 41, in turn driven by a controllable motor 17. The shaft 40 comprises a rightward threaded portion 42 and a leftward threaded portion 43.

The threaded portion 42 is operatively coupled to the upright 33, whereas the threaded portion 43 is operatively coupled to the upright 34.

As is further shown in FIG. 4, the opposite parts of the uprights 33, 34 are also operatively coupled to a driving shaft 20, identical to the shaft 40 and, by driving chains or belts 19, the driving torque transmitted by the motor 17 to the shaft 18 will be also transmitted to the shaft 20, thereby perfectly driving said uprights 33 and 34.

Advantageously, on the top portion of the framework 2 precision guides and screws for driving the uprights 33, 34 are also provided.

The nailing machine 1 operates as follows:

depending on the nailing points at which the pallet 16 must be nailed at the nailing position provided on the plane 17 of the machine, the positions of the grippers P and stem elements S of each beam 8, 9, 10 are at first adjusted.

Such an adjustment of the grippers P and stem elements S can also be automatically performed, by controllably driving the pin or stem elements S and grippers P with respect to the corresponding beams 8, 9, 10 by operatively coupling the grippers P of each cross-member 15, for example, to locating screws connected to controllable motors.

After having adjusted said grippers P and stem elements S, the upright 33 and upright 34 are properly arranged with respect to the workpiece 16 to be nailed and with respect to the locally fixed upright 30.

After having performed this further adjustment operation, is determined the precise nailing position of the pallet 16 supplied, for example, by a controllable conveyor belt or chain, indicated by 17.

With the workpiece 16 arranged of the desired nailing position, all the hydraulic cylinders 11, 12, 13 are simultaneously supplied with pressurized hydraulic fluid, thereby all the cross beams 8, 9, 10 will be simultaneously lowered toward the workpiece 16, so as to actuate the stem elements S, which are simultaneously engaged in the grippers P already supplied with the nails to be used. Thus, by a single lowering stroke, the pins S will simultaneously introduce or drive the nails into the constructional elements forming the pallet 16 to be assembled. More specifically, owing to the provision of the multiple nailing assemblies 8, 9, 10 which can be properly arranged in the inventive nailing machine 1, it is possible to make a pallet by nailing a plurality of nailing points thereof with a single nailing operating stroke, thereby drastically reducing the pallet making time.

Owing to the above disclosed embodiment of the nailing machine 1, comprising a central nailing assembly 9 which is arranged locally fixed and two further nailing assemblies 8, 10 which can be precisely driven and arranged at a desired nailing point, and owing to the provision of precision screws which can be actuated by a controllable motor, the movable nailing assemblies 8, 10 can be properly located in a very reduced time, thereby further drastically reducing the pallet making time, while allowing the nailing machine to be quickly fitted to different pallet sizes to be made.

1. A nailing machine (1) comprising nailing grippers (P) supported by a supporting beam (8, 9, 10) which can be controllably driven in a vertical plane and with nail bins (3, 4, 5) for supplying nails to said grippers (P), characterized in that said nailing machine further comprises a plurality of gripper holding beams (8, 9, 10), movable in a vertical plane, that a central gripper holding beam (9) is supported by a supporting construction (30) which is locally fixedly arranged and that adjoining gripper holding beams (8, 10) are adapted to be adjusted with respect to a workpiece (16) to be nailed.

2. A nailing machine, according to claim 1, characterized in that each gripper holding beam (8, 9, 10) is driven by a plurality of hydraulic cylinders (11, 12, 13), and that the hydraulic cylinders (11, 12, 13) of each nailing gripper (P) supporting beam (8, 9, 10) are hydraulically connected to one another to allow all the gripper holding beams (8, 9, 10) to be simultaneously driven.

3. A nailing machine, according to claim 1, characterized in that said nailing machine (1) comprises a framework (2) which is laterally provided with parallel guides (6, 7) slidably supporting said beams (8, 9, 10).

4. A nailing machine, according to claim 1, characterized in that the framework (2) of said nailing machine (1) comprises, at a top and bottom portions thereof, mechanical guides (31, 32) slidably supporting uprights (33, 34) in turn supporting said gripper holding beams (8, 10).

5. A nailing machine, according to claim 1, characterized in that said framework (2) supports, on both sides thereof, threaded driving shafts (20, 40), said threaded driving shafts being rotatably supported by said locally fixed framework (2), that each shaft (20, 40) comprises a threaded portion (42) having a thread extending in a direction and a further threaded portion (43) having a thread extending in an opposite direction.

6. A nailing machine, according to claim 1, characterized in that one (20) of said threaded shafts is operatively coupled to a geared unit (41) driven by a controllable motor (17).

7. A nailing machine, according to claim 6, characterized in that said nailing machine comprises a driving shaft (18) which, through drive chains or belts, operatively drives further shafts (20).
